(19) United States
(12) Patent Application Publication
(10) Pub. No.: US 2002/0078090 A1
(43) Pub. Date: Jun. 20, 2002

(54) Ontological concept-based, user-centric text summarization

(76) Inventors: Chung Hee Hwang, Austin, TX (US); Bradford Wayne Miller, Austin, TX (US); Marek E. Rusinkiewicz, Austin, TX (US)

Correspondence Address: DEWAN & LALLY LLP, PO BOX 684749, AUSTIN, TX, 78768, US

(21) Appl. No.: 09/895,799

(22) Filed: Jun. 29, 2001

Related U.S. Application Data
(60) Provisional application No. 60/215,436, filed on Jun. 30, 2000.

(51) Int. Cl. G06F 15/00

(52) U.S. Cl. 707/513

(57) ABSTRACT

A method and system for constructing a text summarization. At least one domain ontology that includes a set of concepts is selected. A user profile indicative of a user's interests is defined in terms of the ontology concepts. A document's relevance to the user is determined based upon the user profile. If the document is relevant, at least a portion of the ontology is used to extract concepts from the document. The degree of match between the extracted concepts and the user profile concepts is determined and the document text summary is generated if the degree of match exceeds a predetermined threshold. Generating the summary may include selecting sentences based on the concepts in the user profile, ranking the selected sentences by relevance to the user profile, selecting sentences for inclusion in the document text summary based upon the ranking, and merging the selected sentences into the document text summary.

This application claims priority under 35 USC § 119(e)(1) from the provisional patent application entitled, CONCEPT-BASED ONTOLOGY TEXT SUMMARIZATION, Serial No. 60/215,436, filed Jun. 30, 2000.

### BACKGROUND

1. Reference to a Related Application

The present invention is related to co-pending U.S. patent application, Hwang et al., Dynamic Domain Ontology and Lexicon Construction, Attorney docket number MCC.5102, filed on the same date as the present application [referred to hereinafter as the “Ontology Construction Application”], which shares a common assignee with the present application and is incorporated by reference herein.

2. Field of the Present Invention

The present invention generally relates to the field of text document processing and Information Retrieval (IR) and Information Extraction (IE) and more specifically to the generation of document summaries in a natural language.

3. History of Related Art

With the advent of computers, the nature of problems in information acquisition has changed from not having enough information to having too much information. This problem is becoming exponentially more serious with the growth in information available via such means as, but not limited to, the Internet, intranets, and digital libraries. Hence, much attention has been paid to filtering out unnecessary information and receiving only the information needed. One method useful for such purposes is text summarization. A text summary, or abstract, allows a user to predict if a document contains information that is useful to him or her, without having to acquire and read the entire document. A text summary also lets a user decide whether it would be worthwhile to actually look at the full document. In order to save the user's time, a text summary should be concise and substantially shorter than the original document. Additionally, the summary should surmise the content of the original document as accurately as possible, retaining as much of the information potentially important to the user as possible. Finally, the summary should be comprehensible and in a fluent natural language.

Document summarization or abstracting existed before the advent of electronic computers. Previously, human agents prepared summaries or abstracts. Common examples are the abstracts of journal articles, which are typically written by the authors of the articles. When an abstract is needed, but an author-written one is not available, then a third person with abstract writing training could generate the abstract. Abstract writing is a time consuming task for a human. Furthermore, with the explosion of information sources, particularly in digital format, including the ever-growing amount of Internet articles, it is unrealistic to expect humans to be able to summarize all of the articles in time to be useful to potential readers. Thus, it is highly desirable to implement a process for generating text summaries automatically.

To date, most automated summarization systems generate generic, one-kind-fits-all summaries, not customized for the individual user's needs and interests. For instance, Withgott (U.S. Pat. No. 5,384,703) discloses a mechanism for developing thematic summaries based on a word list called seed list which includes the most frequently occurring lengthy words. The words used for counting, however, are not related to each other (i.e., they do not represent specific themes or topics and are not associated with ontological concepts), and user interests are not taken into account. Bornstein (U.S. Pat. No. 5,867,164) purports to disclose a mechanism for adjusting the length of a summary with a continuous control, but does not present a novel mechanism for creating the summary. Mase (U.S. Pat. No. 5,978,820) and Kupiec (U.S. Pat. No. 5,918,240) also disclose the generation of generic summaries.

Since every user would have different interests and information needs, one-kind-fits-all type summaries have limited usefulness. Researchers have been realizing the importance of user-focused summaries, and there have been attempts to construct summaries by considering the words a user has used in submitting a query. However, even if user interests are considered, as is the case in the systems described by T. Strzalkowski, G. Stein, J. Wang & B. Wise, Advances in Automatic Text Summarization: A Robust Practical Text Summarizer, pp 137-154, (MIT Press, 1999) or I. Mani and E. Bloedorn, Information Retrieval: Summarizing Similarities and Differences Among Related Documents, pp 35-67, v1 (1999), such consideration is typically limited to expanding the set of keywords the user has used in formulating the query. Nakao (U.S. Pat. No. 6,205,456) discloses summarization apparatus and method, but the method also relies on words that appear in the question sentence only.

The retrieval or extraction of information based on keywords (a well known technique) may have limited success because of mismatches between the words a user chooses to use in the question or search and the words the document creator has used to express the same concept. That is, the same concept may be expressed in various ways using different words. The user needs to know what kinds of words would have prolific results for his query, and the author or cataloguer of documents should use the words that are likely to be used by the searcher in order to get the document maximal retrieval.

Information access would be done more precisely if users are able to query by way of concepts, rather than with a static set of keywords. Hence, it is important to allow users to define their interests or to formulate queries using “well-defined” concepts, using terms generally accepted by subject matter experts. Ontologies are useful for such purposes as they provide a defined vocabulary with which to share and reuse knowledge. There has been much effort to develop methods for automatically constructing ontologies (this is presented in T. R. Gruber, Toward Principles for the Design of Ontologies Used for Knowledge Sharing, Proceedings of the International Workshop on Formal Ontology: Conceptual Analysis and Knowledge Representation, pp 1-17, Padova, Italy, Mar. 17-19, 1993). The co-pending Ontology Construction Application describes a method and system for automatically constructing an ontology from a collection of documents (See also, C. H. Hwang, Incompletely and Imprecisely Speaking: Using Dynamic Ontologies for Representing and Retrieving Information, In Proceedings of the 6^{th} International Workshop on Knowledge Representations Meets Databases, pp 14-20, Linkoeping, Sweden, Jul. 29-30, 1999). Users can use such automatically created ontologies to define their interests. Once users define their interests with concepts that appear on the ontology, they do not have to worry about which keywords they have to use in submitting their queries or in specifying their interests. In addition, since ontologies are constructed as hierarchy of concepts, by selecting a higher-level concept, a user automatically selects all the sub-concepts within the ontology structure. Once a user specifies his or her interests by way of ontological concepts, it becomes possible for a computer system to automatically generate a text summary from a document focused on the user's interests.

### SUMMARY OF THE INVENTION

The problems identified above are addressed by a system and method for generating text summaries of one or more documents based on user interests as specified in his profile. Initially, a hierarchical ontology consisting of domain concepts is constructed, and one or more parts on the ontology that are specific to the user's interests are identified. The summarization system is an automated system that uses the selected parts of the ontology to scan documents for sentences that contain information relevant to the concepts that appear in the selected parts of the ontology. Sentences found to comply with the specified concepts are extracted from the document and given a relevance score based on the ontological concept match, pre-selected user interest-specific concepts, and the strength of the concepts. If the relevance of the document is larger than a user defined threshold, the system extracts the relevant concepts together with the sentences or a region of sentences such as paragraphs in which they occur. The system then determines the themes running through the extracted portions of the document. Words and phrases whose frequencies yield high relative to their prior probabilities are selected as themes. Themes do not have to be ontological concepts. If the system is operated in an on-line fashion, then the system presents the concepts and the themes contained in the document to the user. If the user is sufficiently interested, a text summary may be requested. If the system is operated in a batch or off-line mode the system computes the degree of relevance of the document from the degree of concept relevance and the degree of relevance between the themes and the user's background interest. The system allows users to determine summary length by either defining a fixed limit on the number of words or a percentage length based on the documents being summarized. Finally, since the system uses hierarchically structured ontologies, it can easily broaden or narrow the conceptual scope of the summary. Similarly, the system may re-generate a more specialized summary by focusing on specific concepts or themes. New information may be retrieved by utilizing a web crawler to collect documents then processing the retrieved documents against pre-selected, user-specific concepts as defined by the client or inferred by the system in order to execute a continual text summarization method.

### BRIEF DESCRIPTION OF THE DRAWINGS

Other objects and advantages of the invention will become apparent upon reading the following detailed description and upon reference to the accompanying drawings in which:

FIG. 1 is a block diagram of a data processing system suitable for implementing the present invention;

FIG. 2 is a flow diagram of the personalized summarization system;

FIG. 3 is a flow diagram depicting a detailed method of constructing the summarization process; and

FIG. 4 is a diagram demonstrating an example of the use of interests defined in an ontology.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

In general this invention relates to automated text summarization using concept-based, hierarchical ontologies generated as described in the co-pending Ontology Construction Application. A text summarizer extracts pieces of information defined as relevant by the user's ontology selection and develops a natural language summary of a document or set of documents. Ideally, the text summarization method produces a summary that is similar in format to human-generated abstracts of journal articles. The text summarization system identified in this invention is also capable of generating multiple summary results depending on the user's ontology selection, which relies on the individual's pre-selected concept selections.

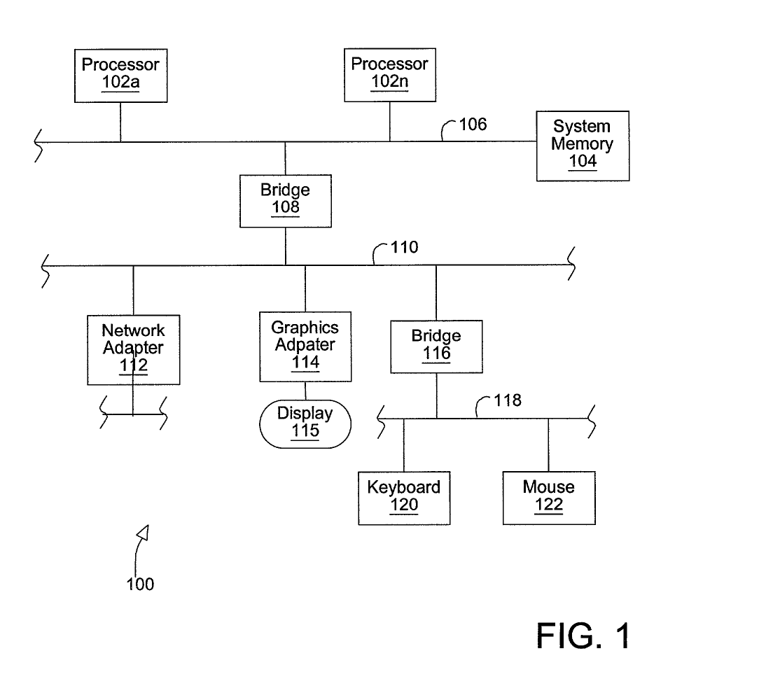

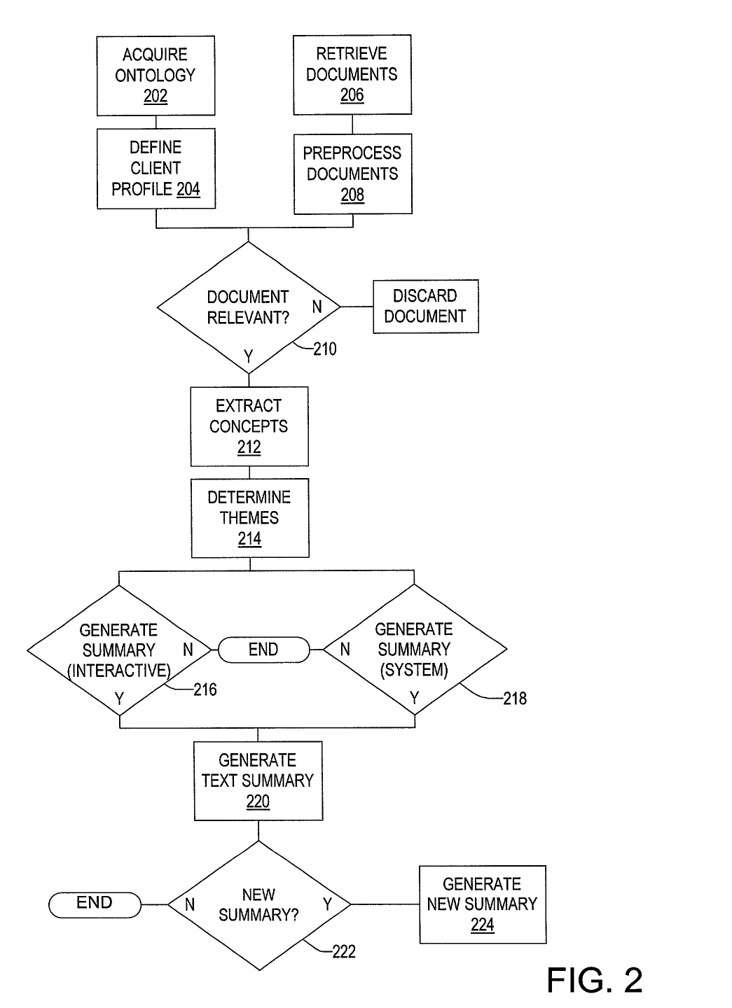

The methods described below may be implemented as a set of computer executable instructions (software) that is encoded on a computer readable medium such as a floppy diskette, a CD ROM, a DVD, tape unit, hard disk, flash memory device, ROM, RAM (including SRAM and DRAM), or any other suitable storage medium. In this embodiment, the software or portions thereof may be contained in a suitable data storage device of a data processing system. Turning to FIG. 1, a block diagrams of a data processing system 100 storing and executing software written to implement the methods described in greater detail below with respect to FIGS. 2 through 4 is depicted. In the depicted embodiment, the data processing system 100 includes one or more processors 102a through 102n (generically or collectively referred to herein as processor(s) 102) that are interconnected via a system bus 106. Processors 102 may comprise any of a variety of commercially distributed processors including, as examples, PowerPC® processors from IBM Corporation, Sparc® microprocessors from Sun Microsystems, x86 compatible processors such as Pentium® processors from Intel Corporation and Athlon™ processors from Advanced Micro Devices, or any other suitable general purpose microprocessor. A system memory 104 is accessible to each processor 102 via system bus 106. A host bridge 108 couples system bus 106 with a first peripheral bus 110. In one embodiment, the first peripheral bus 110 is compliant with an industry standard peripheral bus such as the Peripheral Components Interface (PCI) bus as defined in the PCI Local Bus Specification Rev. 2.2 available from the PCI Special Interest Group at www.pcisig.com.

Peripheral bus 110 enables multiple peripheral devices to communicate with processor(s) 102. A high speed network adapter 112 connects data processing system 100 with additional data processing systems in a network 500 of data processing systems. Data processing system 100 may further include a graphics adapter 114, which controls a display device 115, as well as a variety of other adapters (not depicted) such as a hard disk adapter for controlling a permanent (non-volatile) mass storage device. In the depicted embodiment, data processing system 100 includes a second bridge 116 that couples the first peripheral bus 110 to a second peripheral bus 118. In one common arrangement, first peripheral bus 110 is a PCI bus and second bridge 116 is a PCI-to-ISA bridge that provides for an Industry Standard Architecture compliant second bus 118 to which input/output devices such as keyboard 120 and mouse 122 are attached. Thus, each data processing system 100 typically provides one or more processors, memory, an input device such as keyboard 120, and an output device such as display 115.

FIG. 2 illustrates a method 200 of personalized summarization according to one embodiment of the invention. Initially, an ontology is selected or acquired (block 202). The acquired ontology will guide the text summarization process by providing a concept-based, hierarchical description of the relevant documents. The ontology may be acquired manually or obtained by an automated process such as the process described in the co-pending Ontology Construction Application. The selected ontology includes one or more concept terms.

After acquiring an ontology, user profiles, in which each user defines his or her area(s) of interest areas, are then defined (block 204). The defined user profile contains information that indicates the user's interests. Typically, these interests are indicated using concept terms that occur in the selected ontology. In one embodiment, user profiles are defined with an interactive process in which the client responds to a series of questions. In another embodiment, the user profile is pre-generated and stored in a database. User profile information is then looked-up and retrieved from the database. In still another embodiment, the user profile may be automatically constructed by way of user modeling, which involves looking at the history of the user's information seeking and using activity and determining set(s) of predominant concepts that commonly appear in the documents in which the user had expressed interests.

The areas or concepts specified as interesting in the user profile may be as specific or as general as the client desires. Clients may provide extra constraints and background interests to their profiles. For instance, a user profile might indicate a specific interest in the domain concept “robotics” and a background constraint of “manufacturing” thereby narrowing the scope of the summary to robotic information that is relevant to manufacturing.

Documents are received for processing as indicated in block 206. Virtually any type of document may be received provided that the document has not yet been processed and is in digital format. In one embodiment, new documents are retrieved automatically by periodically invoking a web crawler to retrieve documents from the internet. Each retrieved document may by preprocessed (block 208). Document preprocessing may include identifying document structure information such as information about the title, headings, tables, figures, paragraph boundaries, etc. In addition, document pre-processing may include part-of-speech analysis in which words in the document text are labeled according to their corresponding part-of-speech (noun, verb, adjective, advert, participle, etc).

For each client, and for each new document, a decision is made (block 210) to retain the document or discard it. The relevance decision is made by comparing the document text with information provided in the client profile that was specified in block 204. If a document is not considered relevant to the client, it is removed from consideration and the next document is evaluated.

If a document is determined to be relevant in block 210, relevant concepts are extracted (block 212) from the document using the concept extraction techniques described in the co-pending Ontology Generation Application. The concept terms found in the document that are believed to be relevant to the client's specifications are extracted, organized, and presented to the client. (Note that the concepts that are presented to the client could include a new concept previously unknown to the client).

After extracting the concepts from a relevant document, document themes are determined (block 214). A theme of a document (or part thereof) refers to a topic that makes the story coherent. In the current summarization method and system, themes are topics or concepts that are predominant in a document (or selected portions thereof) but have not been specified in a user profile. For instance, assume that a certain user profile indicates that the client's interest area includes telecommunication and that a certain document describes a new telecommunication equipment manufactured by TLC, Incorporated, a leading company in the telecommunication equipment manufacturing, and the financial profile of the company. Then, the system considers this particular document to be relevant to the specified user since it matches his interests defined in the profile, and at the same time may choose manufacturing and TLC, Incorporated as themes of the document, i.e.,

Document: ABC TodaysNews24062001_2

Concept: telecommunication

Themes: manufacturing; TLC Inc.

It is possible that a document or part thereof may contain more than one theme. The themes of the document that occur simultaneously with the ontological concepts extracted in method 212 are collected and dominant themes are selected. After the document themes are determined, a decision is made whether to generate a summary of the document. In one embodiment, the client decides interactively (block 216) whether to generate a summary. In this embodiment, the client is provided with the ontological concepts and the themes of the document and asked to rate the document or to decide if a text summary is required. The client responses, in addition to determining whether to generate a summary, may be used to update the client's profile. If a summary is requested, the client may be queried as to the length of the summary. The summary may be limited in length to a fixed word count or based upon a percentage of the summarized document. In another embodiment, the system determines (block 218) whether to generate a summary based on an automated comparison between the concepts extracted from the document and the concepts defined in the user profile. If the degree of match between the extracted concepts and the user profile concepts exceeds a predetermined threshold, the summary may be generated. If no summary is required, the current document is no longer considered.

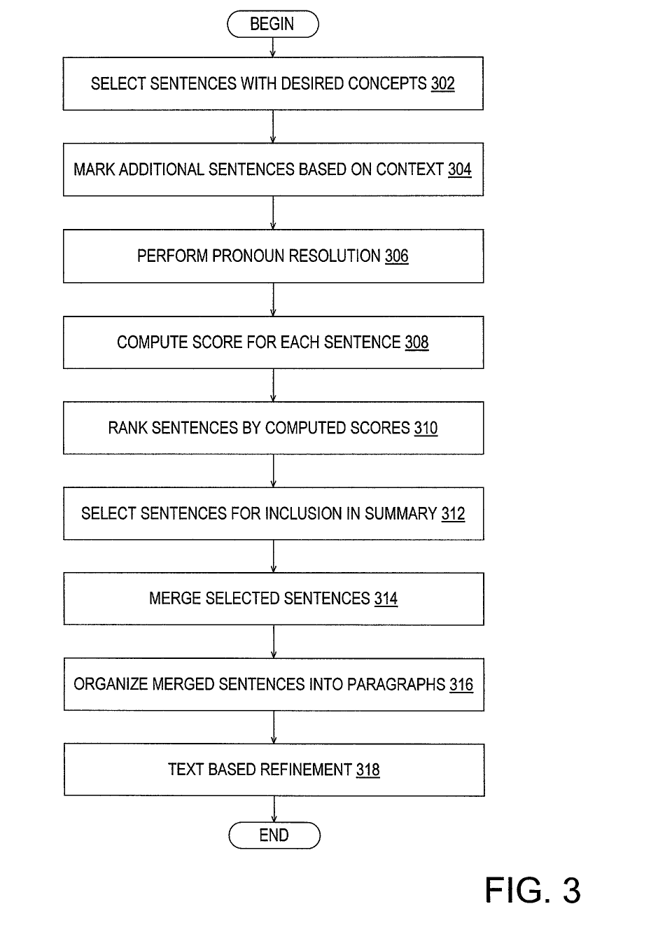

The document summary is then generated in block 220 as described in greater detail below with respect to FIG. 3. In an interactive embodiment, the client may request (block 222) another summary after the initial summary is generated. The user may request a more detailed summary focusing on certain concepts or themes, or a summary of broader scope, possibly without limit on the summary length.

If the user requests additional summaries, the system then generates (block 224) the additional summaries as needed. If the client requests a summary of broader scope, the revised summary may include parent concepts and associated concepts. If the client requests more specialized concepts focusing on specific concepts or themes, undesired concepts are removed to narrow the set of working concepts. Note that it may not always be possible to generate a more specialized summary if the original document does not provide a narrower scope.

Turning now to FIG. 3, a flow diagram illustrating one embodiment of text summary generation block 220 of FIG. 2 is presented. Initially, sentences to extract for summarization are selected (block 302). In one embodiment, all sentences in the original document that contain concept terms that would interest the user (as determined in block 212 of FIG. 2) are marked for selection.

In block 304, additional sentences are marked as candidates to be included in the summary. If a selected sentence contains “context-charged” expressions such as pronouns or referring terms, the sentences prior to it may also be marked for selection. Pronouns are words like it, they, these, etc., that may be used as substitutes for nouns or noun phrases, i.e., referring to some entity that has been mentioned earlier in the document. (Such an entity is called antecedent.) It should be understood that preceding words or phrases may be referred to by either pronouns or by a phrase. For example, once a noun phrase, Mr. John Smith, the Chief Executive of TLC, Inc., is mentioned in a document, the same phrase may not be repeatedly used in the document. Instead, the phrase would be substituted by a pronoun he or a different noun phrase such the chief executive in the rest of the document. In this case, the pronoun he and the noun phrase the chief executive are examples of referring terms. Such usage of pronouns or noun phrases is called an anaphoric usage.

If the proportion of sentences selected for extraction from a certain region of the document exceeds a predetermined threshold, the entire region may be selected. The document regions may comprise paragraphs or other document sections as defined in processing block 208.

In block 306, pronouns are resolved for obvious cases. Pronoun resolution is a process of determining the word or phrase a pronoun is used as a substitute for. In the case of the above example, the pronoun he will be resolved to the noun phrase, Mr. John Smith, the Chief Executive of TLC, Inc. A paragraph whose first sentence involves an unresolved pronoun may be difficult to understand, unless the sentence also contains its referent. A relevance score for each sentence is then computed in block 308. The relevance score may be based on several factors including conceptual relevancy (based on the concepts selected in block 212), thematic relevancy (based on the theme(s) selected in block 214), and the probability that a particular sentence may contain the antecedent of unresolved anaphora.

The selected sentences are then ranked (block 310) by their score. Based upon the ranking of the sentences and a pre-defined criteria, the sentences that are to be included in the summary are determined in block 312. In one embodiment, the length of the proposed summary, whether user selected or automatically generated, is taken into account in deciding which sentences are to be included. In this embodiment, the score a sentence must achieve before being selected for inclusion in the text summary increases as the desired length of the summary decreases.

The sentences determined for inclusion are then extracted (block 314) along with any desired context information (e.g., which paragraph each sentence is from, etc.) and merged. If the number of sentences is large enough, the sentences may be grouped into two or more paragraphs. Paragraph break points are then determined (block 316) based upon the interdependency between the sentences in the merged text to form paragraphs in the text summary.

In block 318, pronominalization and other further refinement of the output is performed. (Pronominalization is a process of substituting a noun or a noun phrase with a pronoun.) Thus, pronouns may be substituted for nouns when appropriate. In addition, sentences are examined and reworded for fluency, without changing their meaning. A passive sentence, for example, may be changed into an active sentence if the surrounding text is also in the active voice. Note that the selection of anaphoric terms may influence the possible choices at this stage. Finally, in block 320, the refined output is presented to the client as a summary of the document.

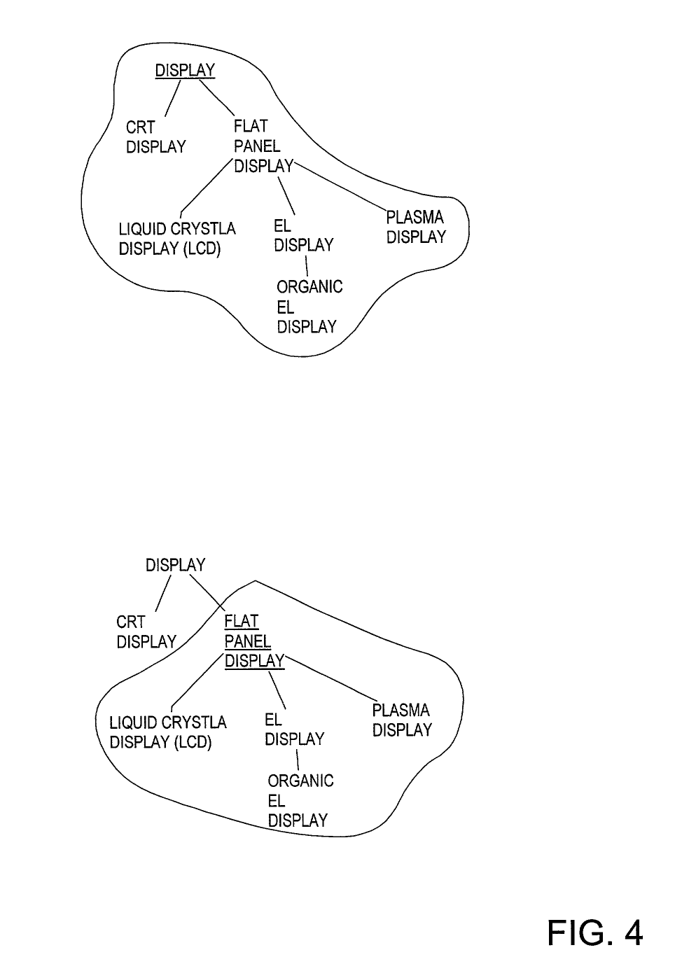

Turning now to FIG. 4, two examples of the area of interest selection made by a client are presented. Consider a simple, hierarchical ontology on DISPLAY technology, as shown in FIG. 4. In the ontology, the main concept is DISPLAY as indicated by the root node. The root node has two child nodes, CRT Display and Flat Panel Display, indicating that CRT Display and Flat Panel Display are two distinct kinds of DISPLAY. In other words, the concept DISPLAY consists of sub-concepts (or subclasses), CRT Display and Flat Panel Display. Next, Flat Panel Display is shown to have three subclasses, Liquid Crystal Display, EL Display, and Plasma Display, whereas EL Display has a subclass, Organic EL Display.

If a client selects the “display” concept as the area of interest, as indicated by the underline in the first example in FIG. 4, all of its sub-concepts, i.e., CRT display, flat panel display, liquid crystal display, EL display, organic EL display, and plasma display, will be automatically considered as the areas of interest for the client, and be included in the determination of what document are relevant, computing the scores of each sentence marked for inclusion, and ultimately, the text that is included in the final summary.

On the other hand, if a client selects the “flat panel display” concept as the domain of interest, as indicated by the underline in the second example in FIG. 4, the sub-concepts from which the relevance determination is made will include liquid crystal display, EL display, organic EL display, and plasma display, but will not include the CRT display concept because it is not a sub-concept of the selected concept.

In addition to defining interest areas by way of concepts in domain ontologies, each client may also define background interests. For instance, a client may be interested in the ontological concept “DISPLAY” with a background interest in “MANUFACTURING”, or alternatively in “RESEARCH”.

For each client, when a new document arrives, the system checks if the document is relevant to the client. Processing new documents against pre-selected, client-specific concepts defined by the client, or inferred by the system, and computing the relevancy score for each document, the system can perform a continual text summarization method. The relevance score is computed based on several factors, such as the number of ontological concepts found in the document that match (or are associated with) the pre-selected, client-specific concepts (in case of associated concepts), the strength of the concept (i.e., the inverse of the distance on the ontology between the interesting-concept and the corresponding concept found in the document), the number of matches, etc. If the relevance of the document is larger than a user defined threshold, the system extracts the relevant concepts together with the sentences, or a region of sentences such as paragraphs, in which they occur. The system then determines the themes running through the extracted portion of the document. Words and phrases whose frequencies yield high with respect to their prior probabilities are selected as themes. Themes do not have to be ontological concepts.

If the system is operated in an on-line fashion, then the system presents the concepts and the themes contained in the document to the client. If the client is sufficiently interested, a text summary may be requested. If the system is operated in a batch or off-line mode, the system computes the degree of relevance of the document from the degree of concept relevance and the degree of relevance between the themes and the client's background interest. For instance, for a client who is interested in liquid crystal displays, a book chapter that mentions it once in a non-salient position, may not be sufficiently interesting to warrant selection for presentation.

The system allows multiple options for determining the length of the summary, such as a predefined limit on the number of words or sentences (e.g., no more that 800 words or 20 sentences) or a predefined percentage limit on the length on the document being summarized (e.g., no more than 10% of the original document length).

Finally, since the system uses hierarchically structured ontologies, it can easily broaden or narrow the conceptual scope of the summary. That is, after receiving a summary focused on Flat Panel Display (as would result from the second example shown in FIG. 4), if a client request another summary with broader concept, DISPLAY, the system can easily produce such a summary. Similarly, the system may produce a more specialized summary by focusing on specific concepts (e.g., focusing on EL Display, a sub-concept of Flat Panel Display as shown in FIG. 4) or themes (e.g., focusing on “manufacturing” aspect of EL Display).

It will be apparent to those skilled in the art having the benefit of this disclosure that the present invention contemplates a method and system for the facilitated generating and maintenance of textual summarization. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A method of constructing a text summarization, comprising:
selecting at least one domain ontology comprising a set of concepts;
defining a user profile indicative of the user's interests in terms of the concepts in the selected ontology;
determining if a document is relevant to the user based upon the user profile;
responsive to determining that the document is relevant, using at least a portion of the selected ontology to extract concepts from the document;
determining the degree of match between the extracted concepts and the concepts defined in the user profile; and
generating a document text summary if the degree of match exceeds a predetermined threshold.

2. The method of claim 1, wherein generating the document text summary comprises:
selecting sentences from the document based on the concepts in the user profile;
ranking the selected sentences by relevance to the user profile;
selecting sentences for inclusion in the document text summary based upon the ranking; and merging the selected sentences into the document text summary.

3. The method of claim 2, wherein selecting the sentences includes selecting all sentences containing the user profile concepts.

4. The method of claim 3, wherein selecting the sentences further comprises, selecting additional sentences containing antecedents of referring terms.

5. The method of claim 3, wherein selecting the sentences further comprises, selecting all sentences within a region of the document if the proportion of sentences containing concept terms in the region exceeds a predetermined threshold.

6. The method of claim 1, wherein the length of the document text summary is based on either a fixed word count specified by the user.

7. The method of claim 1, wherein the length of the document text summary is based on a percentage of the length of the document being summarized.

8. The method of claim 1, further comprising refining the document text summary including pronominalization of at least a portion of the summary.

9. The method of claim 1, further comprising, prior to determining if a document is relevant, retrieving a document using a web crawler via the Internet.

10. The method of claim 9, further comprising, after retrieving a document, preprocessing the document including identifying document structure information and performing part-of-speech analysis.

11. A computer program product comprising a computer readable medium containing a set of computer executable instructions for constructing a text summarization, the instructions comprising:
computer code means for selecting at least one domain ontology comprising a set of concepts;
computer code means for defining a user profile indicative of the user's interests in terms of the concepts in the selected ontology;
computer code means for determining if a document is relevant to the user based upon the user profile;
computer code means for using at least a portion of the selected ontology to extract concepts from the document responsive to determining that the document is relevant;
computer code means for determining the degree of match between the extracted concepts and the concepts defined in the user profile; and
computer code means for generating a document text summary if the degree of match exceeds a predetermined threshold.

12. The computer program product of claim 11, wherein the code means for generating the document text summary comprises:
computer code means selecting sentences from the document based on the concepts in the user profile;
computer code means for ranking the selected sentences by relevance to the user profile; computer code means for selecting sentences for inclusion in the document text summary based upon the ranking; and
computer code means for merging the selected sentences into the document text summary.

13. The computer program product of claim 12, wherein the code means for selecting the sentences includes code means for selecting all sentences containing the user profile concept terms.

14. The computer program product of claim 13, wherein the code means for selecting the sentences further comprises, code means for selecting additional sentences containing pronouns referring to concept terms.

15. The computer program product of claim 13, wherein the code means for selecting the sentences further comprises, code means for selecting all sentences within a region of the document if the proportion of sentences containing concept terms in the region exceeds a predetermined threshold.

16. The computer program product of claim 11, wherein the length of the document text summary is based on either a fixed word count specified by the user.

17. The computer program product of claim 11, wherein the length of the document text summary is based on a percentage of the length of the document being summarized.

18. The computer program product of claim 11, further comprising code means for refining the document text summary including pronominalization of at least a portion of the summary.

19. The computer program product of claim 11, further comprising code means for retrieving a document using a web crawler via the Internet prior to determining if a document is relevant.

20. The computer program product of claim 19, further comprising code means for preprocessing the document after retrieval including identifying document structure information and performing part-of-speech analysis.

21. A data processing system including processor, memory, and input means, the system further include computer program product code for constructing a text summarization, the code comprising:
computer code means for selecting at least one domain ontology comprising a set of concepts;
computer code means for defining a user profile indicative of the user's interests in terms of the concepts in the selected ontology;
computer code means for determining if a document is relevant to the user based upon the user profile;
computer code means for using at least a portion of the selected ontology to extract concepts from the document responsive to determining that the document is relevant;
computer code means for determining the degree of match between the extracted concepts and the concepts defined in the user profile; and
computer code means for generating a document text summary if the degree of match exceeds a predetermined threshold.

22. The data processing system of claim 21, wherein the code means for generating the document text summary comprises:
computer code means selecting sentences from the document based on the concepts in the user profile;
computer code means for ranking the selected sentences by relevance to the user profile;
computer code means for selecting sentences for inclusion in the document text summary based upon the ranking; and
computer code means for merging the selected sentences into the document text summary.

23. The data processing system of claim 22, wherein the code means for selecting the sentences includes code means for selecting all sentences containing the user profile concept terms.

24. The data processing system of claim 23, wherein the code means for selecting the sentences further comprises, code means for selecting additional sentences containing pronouns referring to concept terms.

25. The data processing system of claim 23, wherein the code means for selecting the sentences further comprises, code means for selecting all sentences within a region of the document if the proportion of sentences containing concept terms in the region exceeds a predetermined threshold.

26. The data processing system of claim 21, wherein the length of the document text summary is based on either a fixed word count specified by the user.

27. The data processing system of claim 21, wherein the length of the document text summary is based on a percentage of the length of the document being summarized.

28. The data processing system of claim 21, further comprising code means for refining the document text summary including pronominalization of at least a portion of the summary.

29. The data processing system of claim 21, further comprising code means for retrieving a document using a web crawler via the Internet prior to determining if a document is relevant.

30. The data processing system of claim 29, further comprising code means for preprocessing the document after retrieval including identifying document structure information and performing part-of-speech analysis.
